(19) United States
(12) Patent Application Publication
(10) Pub. No.: US 2004/0007526 A1
(43) Pub. Date: Jan. 15, 2004

(54) Pumping arrangement for a household water purifier

(76) Inventors: Frederik Dellby, Alvsjo (SE); Anders Haegermarck, Trangsund (SE)

Correspondence Address: PEARNE & GORDON LLP, 1801 EAST 9TH STREET, SUITE 1200, CLEVELAND, OH, 44114-3108, US

(21) Appl. No.: 10/276,388

(22) PCT Filed: May 11, 2001
(86) PCT No.: PCT/SE01/01038

(30) Foreign Application Priority Data
May 18, 2000 (SE) 0001844-0

(51) Int. Cl. B01D 61/14

(52) U.S. Cl. 210/650; 210/767; 210/321.6; 210/416.1

(57) ABSTRACT

This invention relates to a device for a household water purifier in which raw water is pressurized and is filtered by means of inverted osmosis, ultra or nanofiltration or the like. The device is provided with a central unit having a first part (10) comprising a vane pump (12) with a pump housing (16) and a second part (11) comprising a filter connected to the first part. The first part (10) is shaped of plastic or the like and the pump housing is (16) at least partly surrounded by a liner (17), which consists of a material which differs from the material of the pump housing, and the liner (17) is at least partly surrounded by the first part (10).

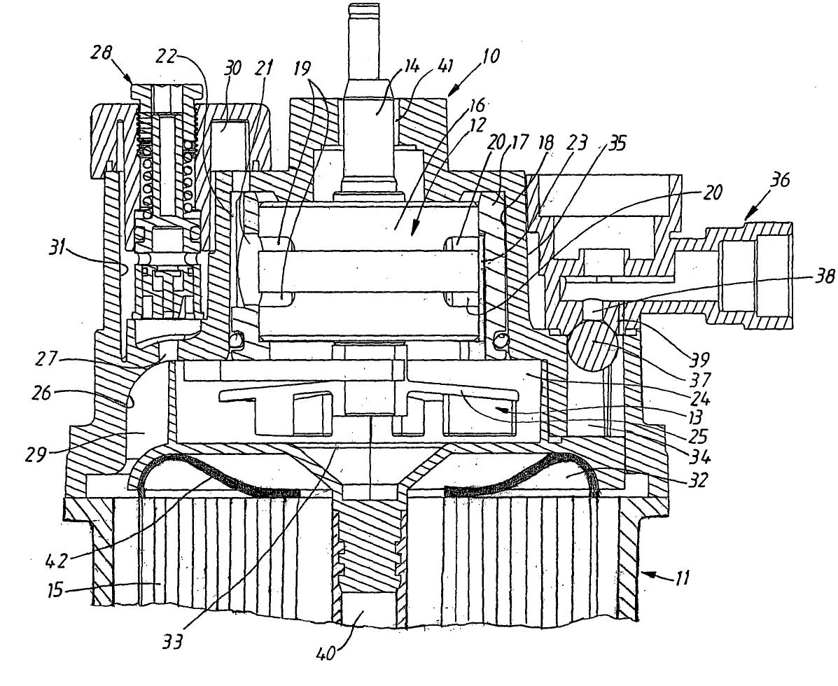

This invention relates to a device for a household water purifier in which raw water is pressurized and is filtered by means of inverted osmosis, ultra or nanofiltration or the like. The device has a central unit with a first part containing a vane pump and a pump housing, and a second part containing a filter connected to the first part.

Water purifiers of the type mentioned above are previously known. See, for instance, European Patent No. 555621. Inflowing raw water is usually subject to pre-filtration by means of conventional means such as mechanical filters, carbon filters, UV-light and so on. In order to achieve the filtration by the water purifier, a membrane is used through which inflowing raw water is forced through the membrane by a pressure of about 10-15 bar. This pressure is created by the vane pump at the same time as particles collected on the membrane are flushed away by a circulating flow. The circulating flow is created by a circulation pump which is driven by means of the same shaft as the vane pump. With previously known water purifiers, the entire first part has been manufactured from brass because of the high pressure, the demand for accurate tolerances, and the risk of corrosion. However, this results in high material costs and complicated and cumbersome machining, which further increases the costs for this part.

This invention simplifies the manufacturing process of the first part and at the same time reduces the material consumption and integrates the surrounding equipment with the first part in order to reduce costs significantly. This is achieved by means of a device having a central unit with a first part shaped of plastic containing a vane pump with a pump housing and a second part containing a filter. The pump housing may be made of graphite and is at least partly surrounded by liner. The liner is made of a material, such as brass, which differs from the material of the pump housing. The liner also is at least partly surrounded by the first part.

A fuller understanding of the invention may be had by referring to the following description and claims taken in conjunction with the accompanying drawing, wherein the drawing is a vertical section through the device according to an embodiment of the invention.

An embodiment of the invention will now be described with reference to the accompanying drawing. A water purifier comprises a central unit having a first and a second part 10 and 11, respectively. The first part 10, which is made from plastic, encloses a vane pump 12 and a circulation pump 13 which are driven by the same shaft 14. The second part 11 comprises a pressure vessel surrounding an osmotic filter, designed as a membrane 15.

The vane pump 12 comprises in a conventional manner a pump housing 16 enclosing a cylindric pump chamber in which several vanes are rotatably arranged by means of the shaft 14. The shaft is supported concentrically with respect to the pump chamber. The vanes are movable radially and are in engagemant with the surrounding cylindrical wall of the pump chamber. The pump housing 16, which is mainly cylindrical, and the vanes are made of a material such as graphite and are surrounded by a reinforcing liner or a sleeve 17. The liner is made of a material which differs from the material in the first part 10 as well as from the material in the pump housing 16. Preferably, the liner 17 is made of metal, for instance brass, and is inserted in a cylindrical recess 18 in the first part. The pump housing 16 also has inlet channels 19 ending in the pump chamber as well as outlet channels 20 directed from the chamber. The inlet channels 19 are by means of an opening 21 in the liner 17 connected to an inlet passage 22 for the water to be purified. This inlet passage 22 extends between the first part 10 and the liner 17. The outlet channels 20 are in a corresponding way connected to an outlet passage 23 arranged between the sleeve 17 and the pump housing 16. This passage 23 is arranged to end in a circulation container 24 in which the impeller 25 of the circulation pump 13 is arranged. One of the walls 26 of the circulation container 24 is designed as a cup shaped recess in the first part 10.

The first part 10 also encloses a connection channel 27 which, via an inlet valve arrangement 28, designed as a separate unit, connects the circulation pump outlet 29 with a raw water inlet 30. This inlet 30 also communicates with the inlet channels 19 via the inlet passage 22 and the opening 21. The inlet valve arrangement 28 is placed in a first socket 31, which is an integrated part of the first part 10.

The circulation pump outlet 29 is connected to one side of the membrane 15 in the pressure vessel whereas unpurified water, so-called reject water, flows out from the pressure vessel via a pressure vessel outlet 32. This outlet 32 is connected to the circulation pump inlet 33 and to a first part outlet 34. The outlet 34 continues into a second socket 35 for an outlet valve arrangement 36, which controls the outflow of the reject water to a sewage drain (not shown). This valve arrangement 26 is provided with a float body formed as a ball 37 arranged in the outlet 34. The ball raises for a certain flow to close an outlet opening 38. There is also a restriction 39 arranged parallel to the outlet opening 38, which allows a reduced flow of reject water independent of the position of the ball 37.

The second part 11, i.e., the pressure vessel, also has a tube 40 through which the purified water is forced out to a tapping point. In this connection, it should also be mentioned that the shaft 14 is rotatably arranged in bearings 41 arranged in the first part. In the figure, there also is a flexible membrane 42 serving as a check valve. With regard to the other details of the valve arrangement and the design and function of the water purifier, reference is made to the Swedish Patent Application No. 0001843-2.

Since the first part 10 is made of plastic instead of brass, (the plastic per se not having sufficient strength for enclosing the pump housing 16 of the vane pump which is made of graphite) an inexpensive component is achieved, which easily and without any machining operation can be manufactured by up-to-date plastic manufacturing tools and which simultaneously integrates certain functions of the surrounding equipment. The first part can then be joined to the reinforcing sleeve 17, which by simple machining methods and a minimum of waste of material can be manufactured from tube elements which are available on the market. The metal liner takes up the forces which occur during pumping.

It should be evident that this disclosure is by way of example and the various changes may be made by adding, modifying, or eliminating details without departing from the fair scope of the teaching contained in this disclosure. The invention is therefore not limited to particular details of this disclosure, except to the extent that the following claims are necessarily so limited.

1. A device for a household water purifier in which raw water is pressurized and is filtered by means of inverted osmosis, ultra or nanofiltration or the like the device comprising: a central unit having a first part (10) containing a vane pump (12) with a pump housing (16) and a second part (11) connected to the first part containing a filter characterized in that the first part (10) is shaped of plastic; the pump housing (16) is at least partly surrounded by a liner (17) made of a first material which differs from a second material in the pump housing; and the liner (17) is at least partly surrounded by the first part (10).

2. A device according to claim 1, characterized in that the liner (17) comprises a metal sleeve, preferably of brass.

3. A device according to claim 1 or 2 characterized in that the liner (17) has a mainly circular section, the liner being arranged in a mainly cylindrical recess (18) of the first part (10).

4. A device according to claim 3 characterized in that the pump housing (16) is cylindrical and has an outer diameter which joins the inner diameter of the liner (17).

5. A device according to any of the preceding claims characterized in that the vane pump (12) is driven by a shaft, and the shaft (14) also supports an impeller (25) for a circulation pump (13).

6. A device according to any of the preceding claims characterized in that the first part (10) has at least one socket with an associated valve arrangement, and a first socket (31) forms an inlet for water which is arranged to communicate with inlet channels (19) in the pump housing (16).

7. A device according to claim 6 characterized in that the first part (10) has a cup-shaped recess forming a wall (26) surrounding the impeller (25) of the circulation pump (13).

8. A device according to claim 7 characterized in that the first socket (31) also is connected to a connection channel (27) ending in the wall (26).

9. A device according to claim 7 characterized in that a second socket (35) is arranged to constitute an outlet for unpurified water, the second socket supporting an outlet valve arrangement (36) comprising a restriction (39) arranged in parallel to a flow controlled valve.

10. A device according to claim 9 characterized in that the flow controlled valve comprises a floating body (37) arranged in the first part (10).
